(19) United States
(12) Patent Application Publication
(10) Pub. No.: US 2002/0055951 A1
(43) Pub. Date: May 9, 2002

(54) Storage medium, information management method and information processing system using said storage medium

(76) Inventors: Takashi Shigetomi, Miyagi-ken (JP); Tetsuo Saito, Miyagi-ken (JP); Eiji Yokota, Miyagi-ken (JP); Shigeru Yokono, Chiba-ken (JP); Yoshimitsu Kobayashi, Tokyo (JP)

Correspondence Address: MERCHANT & GOULD PC, P.O. BOX 2903, MINNEAPOLIS, MN, 55402-0903, US

(21) Appl. No.: 09/749,069

(22) Filed: Dec. 27, 2000

(30) Foreign Application Priority Data
Dec. 28, 1999 (JP) 11-375142

(51) Int. Cl. G06F 15/00

(52) U.S. Cl. 707/501.1

(57) ABSTRACT

The invention provides an information management method comprising the steps of, when connecting a removable storage medium having a program storage area and an information storage area, to an information processing unit on the network; selectively displaying header thumb-nail images corresponding to commercial information such as images, music, voice and documents stored by the storage medium in the information storage area thereof by operating programs stored in the storage medium in the program storage area thereof by the information processing unit; and calling and displaying of corresponding commercial information and/or purchase of information corresponding to the commercial information, and/or purchase of information corresponding to the commercial information, and/or connection to, or registration of, a service provider on the network corresponding to the commercial information, in accordance with selection and instruction of thumbnail images desired by the operator.

### FIELD OF THE INVENTION

The present invention relates to a storage medium, an information management method and an information processing system using such a storage medium. More particularly, the invention relates to a storage medium which provides, by insertion or installation of said storage medium such as a compact disk, into a storage device, automatic startup of a system, commercial display of various services, services such as contract procedure, purchase of commercial products, and guidance retrieval via internet, total information management for users, and an information management method and an information processing system using such a storage medium.

### BACKGROUND OF THE INVENTION

Information exchange, supply of services through internet and e-commerce are now becoming more active than ever, and there are available services permitting connection to internet by a single touch with a menu.

On the other hand, there is provided a system of information management for user employing a storage medium such as a digital album system, as an information processing system, in which image data taken with a digital camera are sequentially assigned identifiers and stored in a disk.

However, the provided functions, as described above, are for simplifying operations for the user to receive a desired service. A commercial function where a user can recognize contents of service without connecting to internet is not provided. As a result, the service of connecting to internet and the information management by the user using a storage medium have conventionally been considered as being quite different from each other, and unification of these processes has not as yet been tried.

### SUMMARY OF THE INVENTION

The present invention provides a storage medium which totally achieve services of permitting automatic startup of a system by insertion or installation of the storage medium, commercial display of various services, and services such as contracting procedure, purchase of commercial products and retrieval of guidance, on the one hand, and user's information management, on the other hand, and an information management method and an information processing system using such a storage medium.

To achieve the aforementioned object, the invention provides an information management method in an information processing system including a network capable of dealing with information such as images, music, voice and documents in large volumes at high speeds, comprising the steps of, when connecting to a removable storage medium having a program storage area storing programs and an information storage area storing information, to an information processing unit such as a computer on a network; selectively displaying a header thumb-nail image corresponding to commercial information such as images, music, voice and document stored in the storage medium in the information storage area thereof by operating a program stored by the storage medium in the program storage area thereof by the information processing unit; and calling and displaying of corresponding commercial information, and/or purchase of information corresponding to the commercial information, and/or connection to, or registration of, a service provider on the network corresponding to the commercial information, in accordance with selection and instruction of a thumb-nail image desired by the operator.

In the aforementioned information management method, the method comprises, when purchasing information corresponding to the commercial information, downloading the purchased information into an information storage area of the storage medium, or when processing a commodity purchase procedure of an information to be purchased, and when downloading the purchased information into the information storage area of the storage medium, registering a header thumb-nail image corresponding to the downloaded information in the information storage area of the storage medium. The aforementioned method comprises, when purchasing information corresponding to the commercial information, downloading the purchased information into the information storage area of the storage medium, or permitting a commodity purchase procedure of an information to be purchased, and when downloading the purchased information into the information storage area of the storage medium, registering a header thumb-nail image corresponding to the downloaded information in the information storage area of the storage medium. When connecting to the service provider or registration thereof corresponding to the commercial information, the method comprises downloading the commercial information of the service provider into the information storage area of the storage medium, and registering a header thumb-nail image corresponding to the commercial information in the information storage area of the storage medium. Also the above-mentioned method comprises the steps of further storing information prepared by the operator such as images, music, voice and documents in the information storage area of the storage medium, selectively displaying header thumb-nail images and reading out and displaying the information in the same manner as in the commercial information. In the same method, the commercial information includes at least one of a still picture, an animation and voice. The animation includes video information, and the voice includes music information. In this information management method, the commercial information includes at least one of network registration and contract information, various contracts information, current affairs information, bicycle race and horse race information, cooking information, fortune-telling information, calendar information, website information, guide information, sales information and rental information. The above guide information includes sight-seeing guide, shopping guide, book guide, education guide, employment guide, housing guide, event guide, marriage guide and fashion guide.

The information processing system of the present invention includes a network, capable of processing information comprising images, voice and documents in large volumes at high speeds, and comprises a removable storage medium having a program storage area storing programs and an information storage area storing information; and an information processing unit such as a computer on the network dismountably mounting the storage medium; the information processing unit comprising display means selectively displaying, when the storage medium is inserted, a header thumb-nail image corresponding to commercial information such as images, music, voice and documents stored by the storage medium in the information storage area thereof by operating a program stored by the storage medium in the program storage area thereof; and service starting means for calling and displaying of the corresponding commercial information, and/or purchase of information corresponding to the commercial information, and/or connection to, or registration of, a service provider on the network corresponding to the commercial information, in accordance with selection and instruction of a desired thumb-nail image by an operator.

The removable storage medium of the present invention has a program storage area storing programs and an information storage area storing information for storing commercial information such as images, music, voice and documents, and thumb-nail information corresponding to the commercial information in the information storage area; and a program storage area for storing a first program module which selectively displays a header thumb-nail image corresponding to the commercial information such as images, music, voice and documents stored by the storage medium in the information storage area thereof, through operation of a program stored by the storage medium in the program storage area thereof by an information processing unit such as a computer; and a second program module for calling and displaying of commercial information, and/or purchase of information corresponding to the commercial information, and/or connection to, or registration of, a service provider on the network corresponding to the commercial information, in accordance with selection and instruction of a thumb-nail image desired by the operator.

The other objects of the present invention will become apparent from the following drawings and the following description in detail.

### BRIEF DESCRIPTION OF THE DRAWINGS

FIG. 1 is a block diagram illustrating a typical configuration of a computer used in the information processing system of this embodiment of the present invention;

FIG. 2 shows an example data storage format of a compact disk in this embodiment of the invention;

FIG. 3 is a flowchart of initial control in this embodiment;

FIG. 4 is a conceptual view of an example of configuration of storage on the compact disk in this embodiment;

FIGS. 5 to 8 illustrate an example of display of the computer when “Net” is selected in the information processing system in this embodiment;

FIGS. 9 and 10 illustrate an example of display of the computer when “Home Page” is selected in the information processing system in this embodiment;

FIGS. 11 and 12 illustrate an example of display of the computer when “Goods” is selected in the information processing system in this embodiment;

FIGS. 13 to 15 illustrate an example of display of the computer when “DigiCam” (Trademark) is selected in the information processing system in this embodiment;

FIG. 16 illustrates an example of display of the computer when “MP3” is selected in the information processing system in this embodiment;

FIGS. 17 and 18 illustrate an example of display of the computer when “Movie” is selected in the information processing system in this embodiment; and

FIGS. 19 and 20 are flowcharts showing the operating procedure of the information processing system in this embodiment.

### DETAILED DESCRIPTION OF THE PREFERRED EMBODIMENTS

To explain the present invention more in detail, embodiments of the invention will now be described with reference to the attached drawings.

### Example of the Computer Forming the Information Processing System in This Embodiment

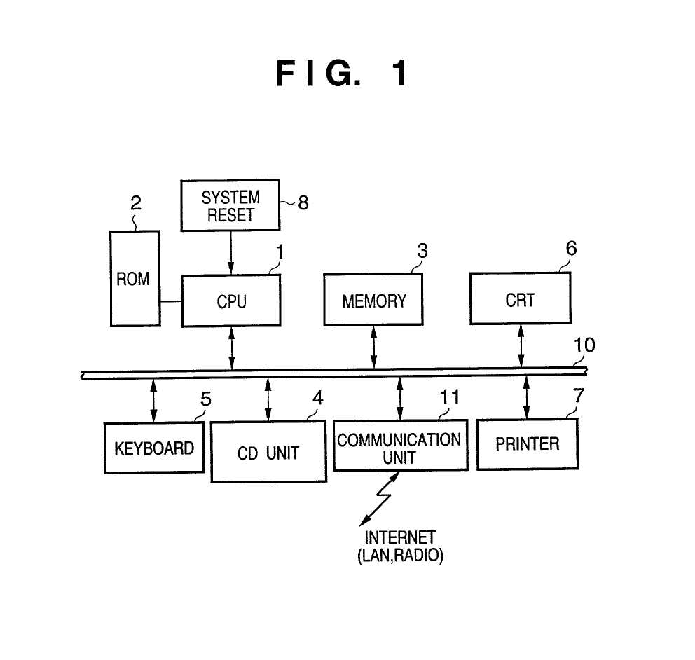

FIG. 1 is a block diagram of a computer forming the information processing system of an embodiment of the present invention. In this embodiment, the information processing system will be described as an example of an image processing system. The present invention is not however limited to this, but is applicable to information processing in general using a storage medium. A CD-RW will be described as a suitable example of the medium storing programs and data. It is however clear that any other storage medium such as a floppy disk can achieve the invention. A partial CD (a CD having a read-only area and a writable area) is more preferable.

In FIG. 1, 1 represents a central processing unit (hereinafter abbreviated as “CPU”) administering the overall control; 2, an ROM storing the least programs for the CPU to read a bootstrap program, a system program and the like from a CD-RW set in a readable/writable compact disk (hereinafter abbreviated as “CD-RW”) unit 4 described later; 3, a memory for storing programs read out from the CD-RW unit 4 or a result of processing; 4, a CD-RW unit; 5, a keyboard; 6, a CRT display unit (hereinafter called “CRT”); 7, a printer for printing the result of processing; 8, a system reset switch for resetting this unit to an initial state; 11, a communication unit connected to internet with wire or by radio, such as LAN; and 10, a system bus connecting various units.

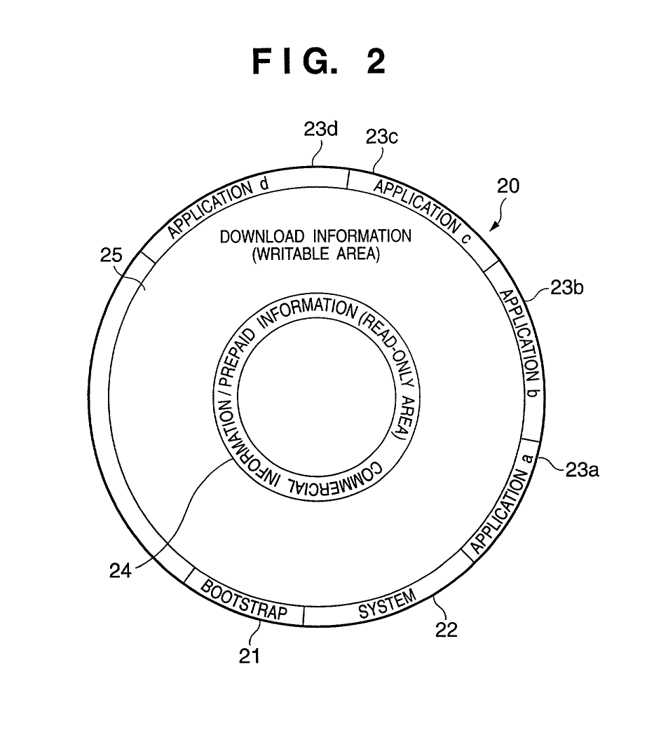

An example of storage format of the CD-RW of this embodiment is illustrated in FIG. 2.

In FIG. 2, 20 represents a CD-RW to be mounted on the CD-RW unit 4 of this embodiment; 21 represents a bootstrap program storage area; 22, a system program storage area; and 23a to 23d, storage areas of packaged application programs a to d.

When using a partial CD, it comprises a read-only storage area 24 storing prepaid information and commercial information (including thumb-nail images), and a writable area 25 storing download information and user-prepared information. Depending upon whether fixed or changeable, the program area may be divided into a read-only area and a writable area. The layout of the read-only area and the writable area shown in FIG. 2 is only an example, and the layout of storage areas is not limited to that shown in FIG. 2. The fixed commercial information includes information prepared as services and information provided for customers purchasing the storage area. That is, the storage medium of the invention serves as a medium having functions of advertisements in brochures, PR catalogs, newspapers and magazines.

The programs stored in the bootstrap storage area 21 and the system program storage area 22 have contents varying with the environment provided by the system main body shown in FIG. 1. When the system main body has no OS, for example, an OS would be stored in the system program storage area 22. On the other hand, when the system main body has an OS, the system program storage area 22 suffices to store only a main control program regarding the information management according to the invention.

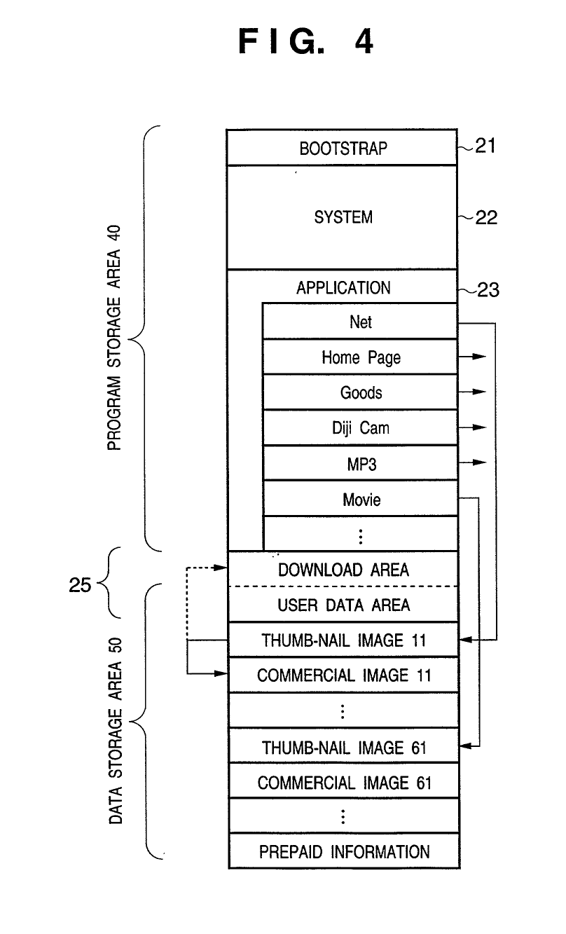

FIG. 4 is a schematic view of an outline of programs or information stored in the CD-RW and the relationship between them.

In FIG. 4, the storage areas of the storage section are broadly classified into a program storage area 40 and a data storage area 50. The program storage area 40 has a bootstrap program area 21, a system program area 22, and an application program area 23, and the application program area 23 contains a “Net” processing application, a “Home Page” processing application, a “Goods” processing application, a “DigiCam” processing application, a “MP3” processing application, and a “Movie” processing application. In addition, this area may contain various contract information, stock market information, current affairs information, cycle race and horse race information, cooking information, fortune-telling information, calendar information, home page information, guide information, sales information, rental information, and guide information such as sight-seeing guide, shopping guide, book guide, education guide, employment guide, housing guide, event guide, marriage guide and fashion guide. From these pieces of information, selection and combinations are made in response to the taste and choice of clients and users. Or, many kinds of information may be grouped into a hierarchy (tree structure) so as to permit sequential searching of information.

One or more sets of thumb-nail images and commercial information read out from such thumb-nail images corresponding to the above processing applications are stored in the data storage area 50. The commercial information is prepared from still images, animations, voice, music and combinations thereof. Prepaid information may be contained in the data storage area 50.

Apart from the above-mentioned area not permitting rewrite by the user, there is available a storage area permitting rewrite by the user. This area contains, via internet or the like, a download area in which programs, data or commercial information are downloaded, and a user data area storing information prepared by the user such as DigiCam information.

Although a detailed description is omitted here, the hardware of the information processing system of this embodiment and the software for information processing or the software for data processing should preferably have the following functions:

### Example of Functional Specifications

Selection within a covered range is performed with a mouse (selection of outline of article)

Resolution: at least 75 dpi

Number of colors: at least 256

Corresponding formats:

Read: JPG, BMP, PIC, TIF, GIF

Write: JPG, BMP

Other functions

Color changing function

Contrast changing function

Clearness changing function

Sharpness changing function

□ E Square selecting function: adjustable range

★ Free selection function: adjustable range

Deformation: Image size changing function: Simple enlargement, contraction, Expansion and contraction without changing resolution: −20 to 800%

To achieve these functions, for example, an internet connecting program, a thumb-nail image preparing program, a thumb-nail image management program, a commercial information management program, an image display program, an animation display program, a data input/output program, a data storing program, an image/voice processing program, a data transmitting/receiving program, a data converting program, a user identifying program, an accounting program and the like are stored in the system program storage area 22 or in the application program storage area 23. Parameters used in the above programs, commercial information, thumb-nail image information, and user management information are stored in the data area 24 or 25. The data area, having a large capacity, can store downloaded animations. When the data area has only a small capacity, however, this CD-RW disk may be used only for information management, and the information main body may be stored in another medium to share functions.

Examples of operation based on the CD-RW disk in an embodiment of the invention will now be described. The following description will cover a case where there are provided registration in network (main menu “Net”), selection of, and connection to, a home page (main menu “Home Page”), commercial and order of goods (main menu “Goods”), management of DigiCam images (main menu “DigiCam”), commercial and order of music/voice (main menu “MP3”), and commercial and order of movies and video (main menu “Movie”). However, a registration and contract information for other network, information about various contracts, stock dealing information, current affairs information, cycle race and horse race information, cooking information, fortune telling information calendar information, home page information, sales information and rental information may be contained, and a sight-seeing guide, a shopping guide, a book guide, an education guide, an employment guide, a housing guide, an event guide, a marriage guide and fashion guide may be included in the guide information. The kind, the number and the priority of these pieces of information in selecting any of them may vary with the bracket to which this CD-RW disk is to be sold. When an increase in the number of menus causes complexity, it is conceivable to deepen the hierarchy by grouping them.

### Example of Startup Procedure by CD-RW Disk of Information Processing System

1. After inserting the CD-RW, causing automatic startup (boots, system) and displaying the menu.

2. Using the browser for display of the main menu; contents of menu: “Net”, “Home Page”, “Goods”, “DigiCam”, “MP3” and “Move”.

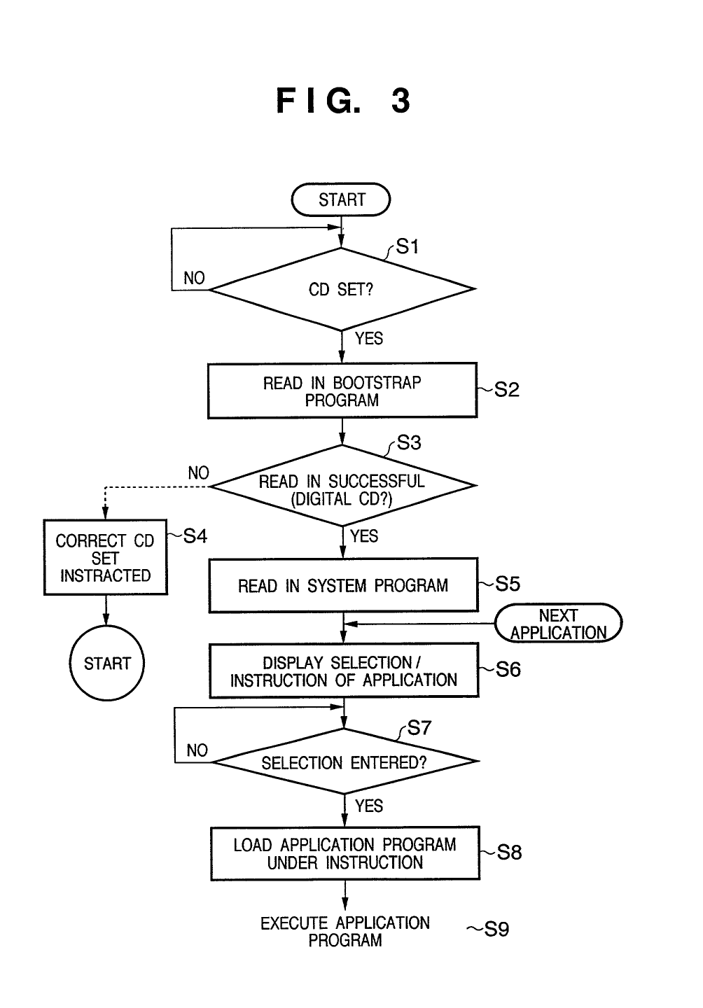

An example of procedure from insertion or installation of the CD-RW disk to the menu display will now be described with reference to the flowchart shown in FIG. 3.

When turning on the power supply of the apparatus shown in FIG. 1, and when the system reset switch 8 is pressed down, or when the apparatus OS is already in operation, the initial control shown in the flowchart of FIG. 3 is executed upon insertion or installation of the CD-RW into the drive.

First, setting of the CD-RW into the CD-RW unit 4 apparatus is monitored in step S1. Upon setting of the CD-RW, the process proceeds to step S2, and the CPU 1 accesses the least program incorporated in the ROM 2 or the bootstrap program storage area 21 in the CD-RW in accordance with the apparatus OS to reads in the bootstrap program.

In the following step S3, it is checked whether or not the bootstrap program has been read in. If not, the process returns back to step S1, or, as shown in FIG. 3, turns on an indicator informing “loading not allowed” or not “digital CD-RW” not shown, attached to CRT 6 or the outer side of the apparatus to notify the operator (step S4).

When read of the bootstrap program is successful in step S3, and the set CD-RW is a digital CD-RW, the system program (the system program includes, for example, the operating system (OS)) is read in by use of the bootstrap program in step S5. Subsequently, processing is performed in accordance with the system program thus read in.

For example, in step S6, a selection screen of currently selectible and executable application programs is displayed on the CRT 6; in step S7, selection and input are waited for; upon selection and input, in step S8, a corresponding application program is read in from the CD-RW unit 4; as shown in step S9, processing is carried out in accordance with the read-out application program.

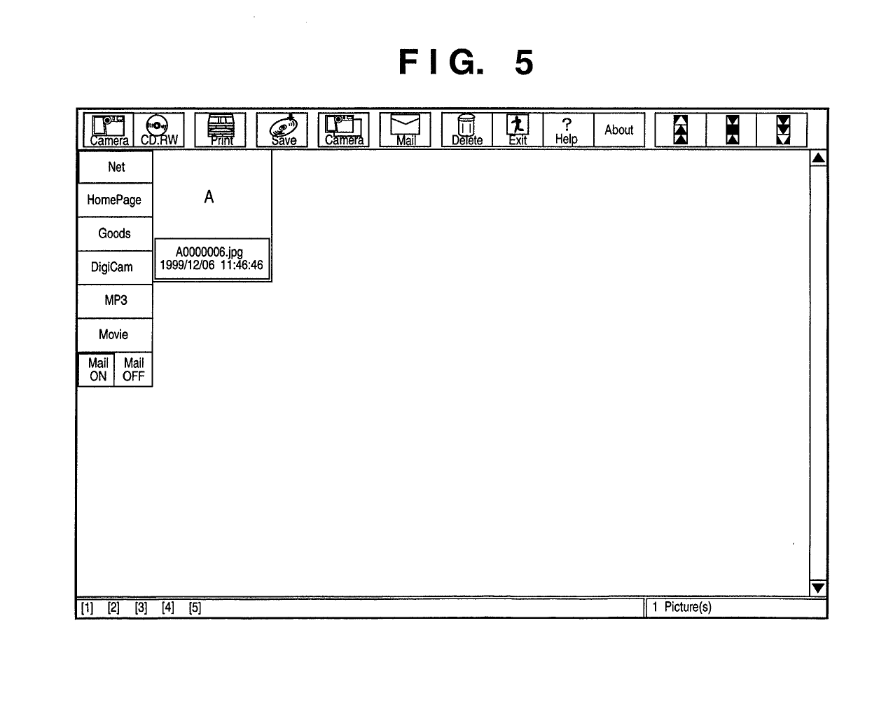

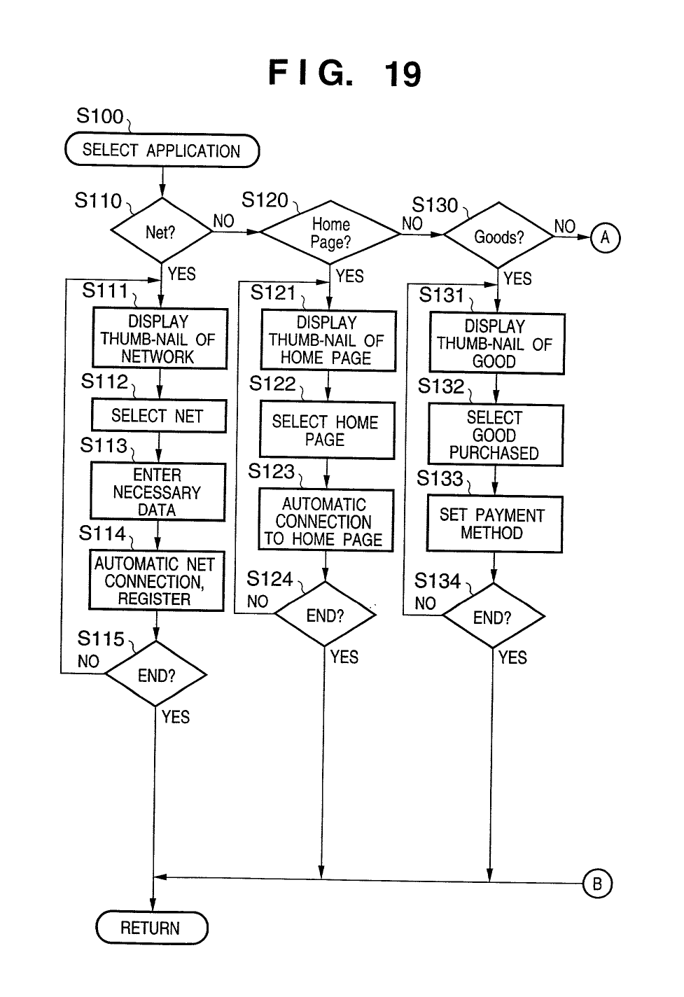

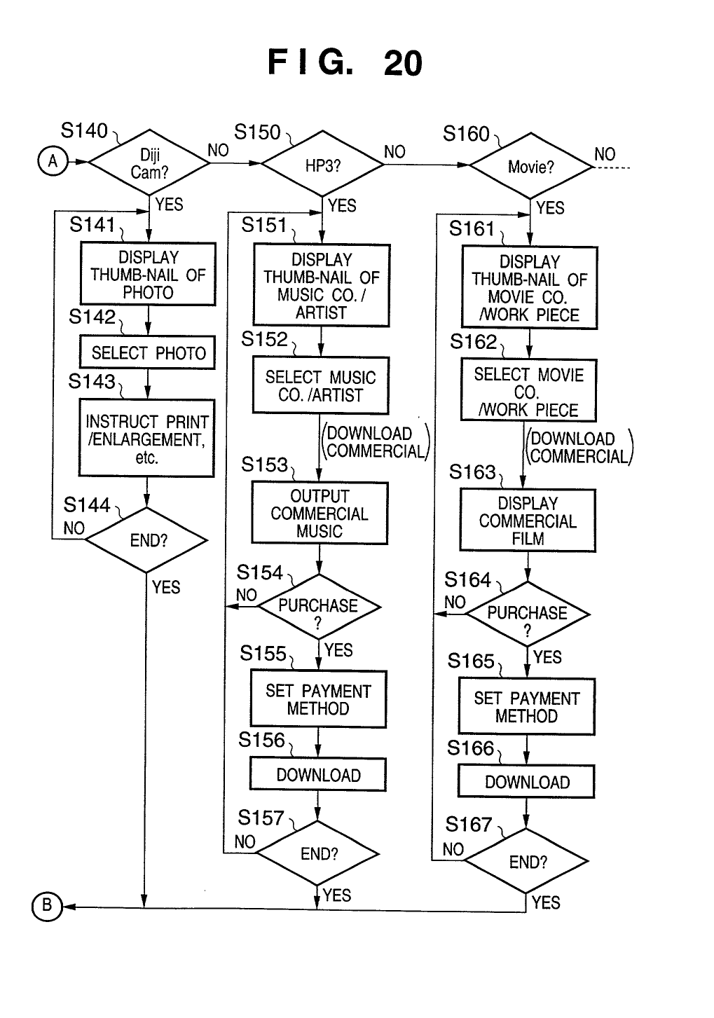

An example of selection screen of application, an example of display of a thumb-nail image upon selection of the above-mentioned main menus, and commercial information when one of the thumb-nail image is selected are shown in FIGS. 5 to 18. The operating procedure for achieving these operations is schematically shown in the flowcharts of FIGS. 19 and 20.

### Example of Operating Procedure of Information Processing System

An example of operating procedure of the information processing system will sequentially be described with reference to FIGS. 5 to 20. The advantages of the invention do not vary as a result of a change in the order of steps.

First, in step S100 shown in FIG. 19, one application is selected from the main menus “Net”, “Home Page”, “Goods”, “DigiCam”, “MP3”, and “Movie”.

### Net Processing

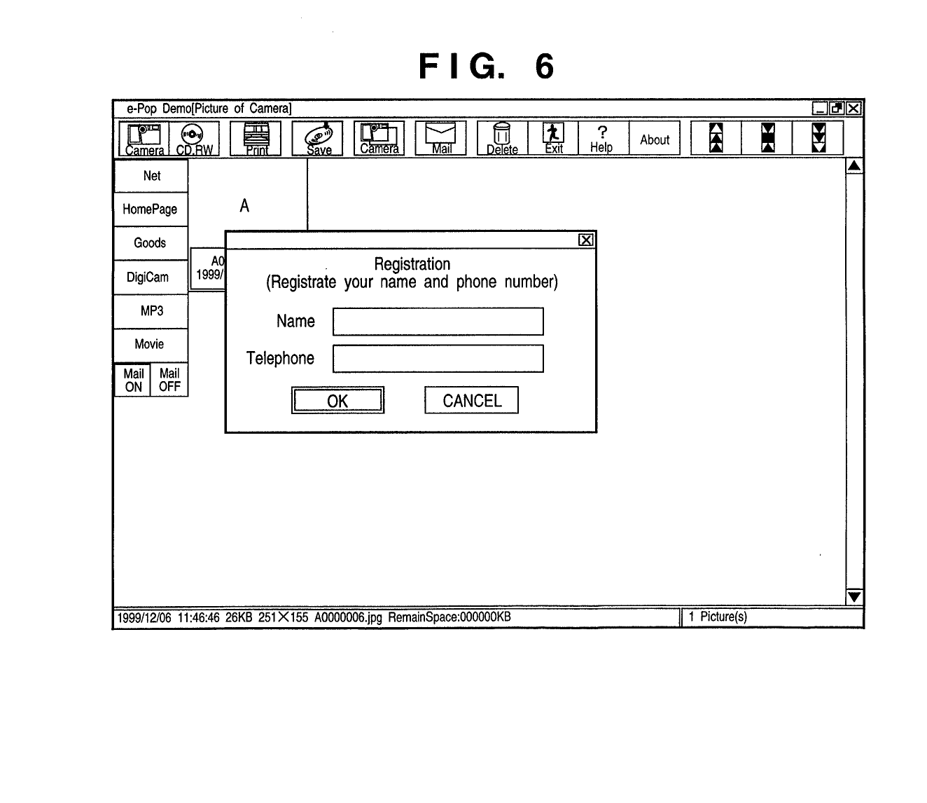

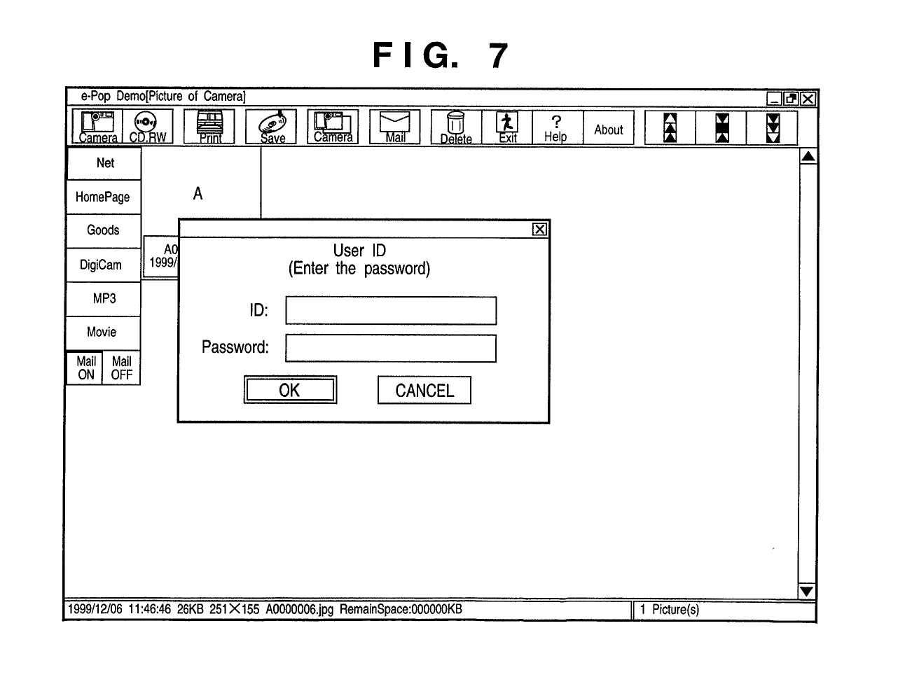

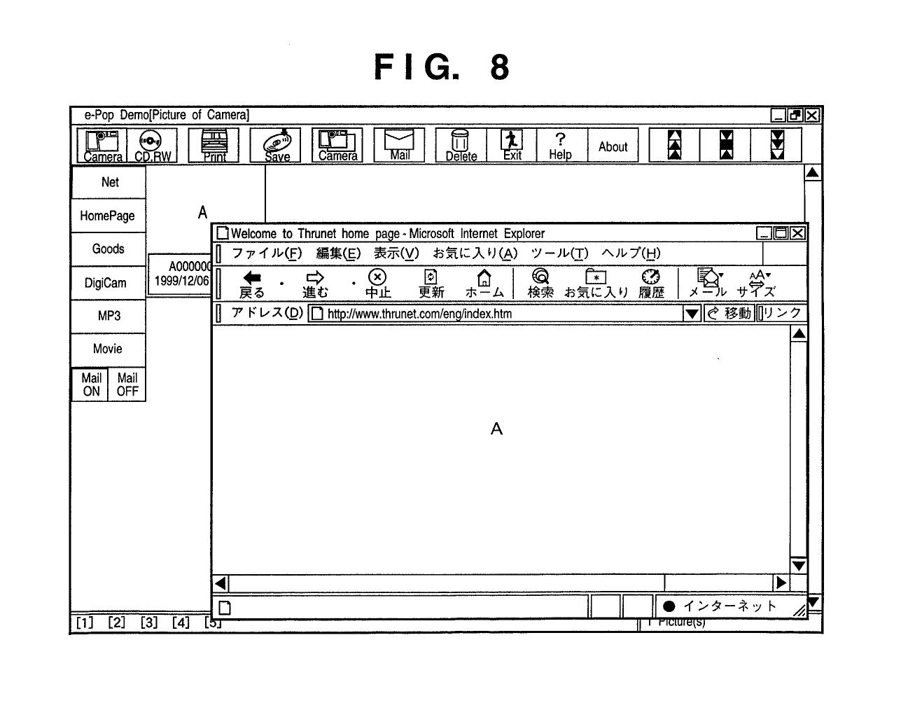

When “Net” is selected, the process goes from step S110 to S111, and a thumb-nail image showing the kind of network is displayed as shown in FIG. 5. While FIG. 5 shows only one network “A”, a plurality of networks may be displayed. Then, in step S112, the user selects a desired network by clicking the mouse. Then, in step S113, as shown in FIGS. 6 and 7, a name or a telephone number, or a user ID or a password is entered. Upon the completion of this input, in step S114, connection is automatically made to the network “A” in this embodiment and registration is conducted, and a display as shown in FIG. 8 is shown. This image is registered as a thumbnail image as one of “Home Pages” explained in the following paragraph. In step S115, it is determined whether end or not of the “Net” processing application. If not, the process returns back to step S111 to display the thumb-nail again to wait for the next input.

### Home Page Processing

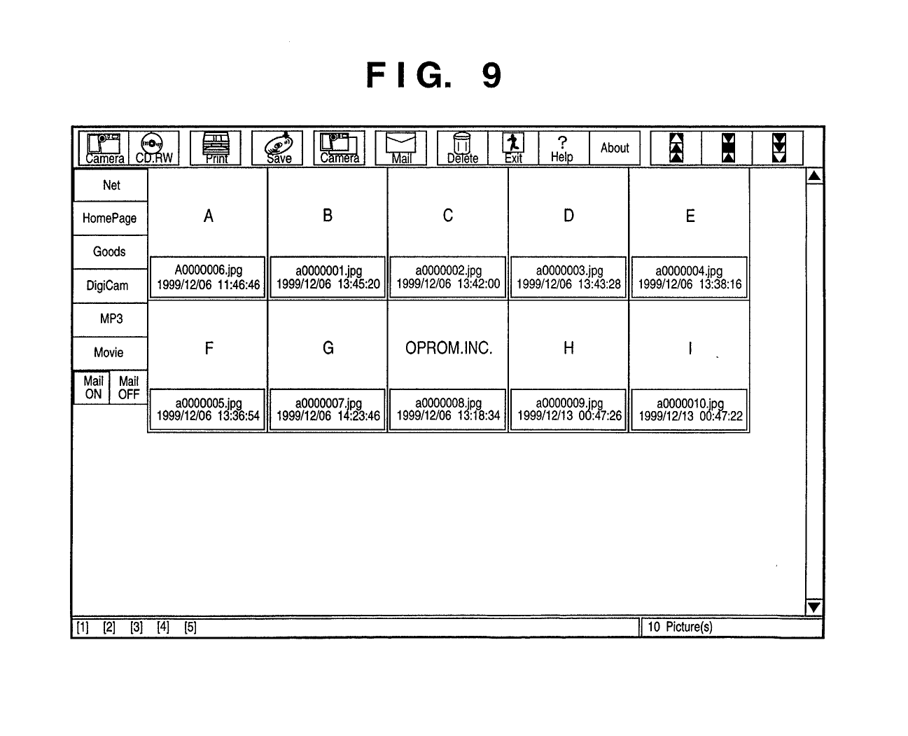

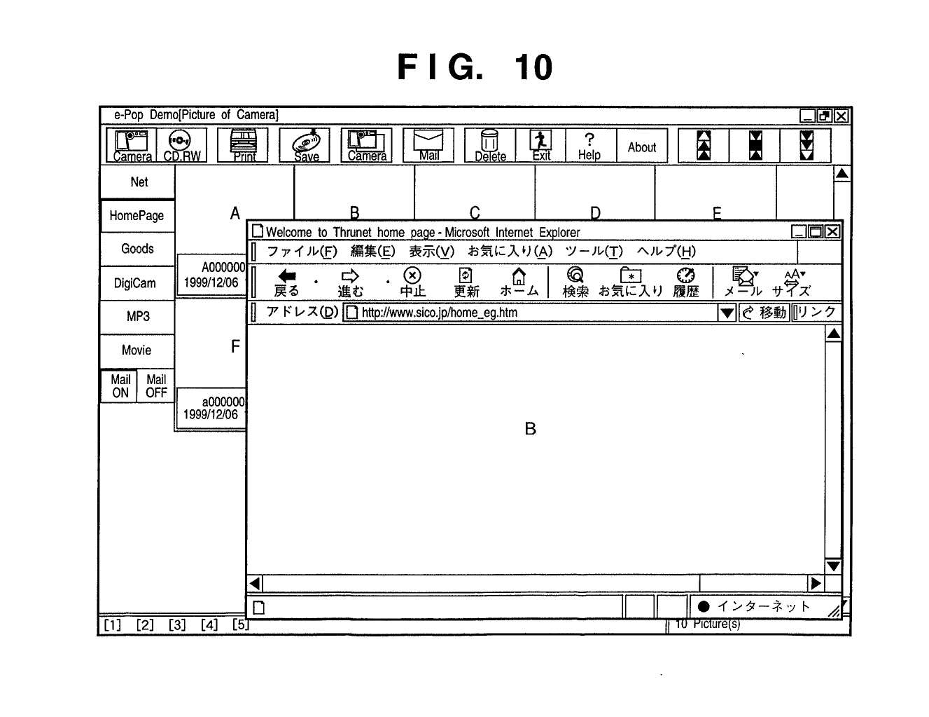

When “Home Page” is selected, the process moves from step S120 to S121, and as shown in FIG. 9, thumb-nail images showing home pages are displayed. FIG. 9 illustrates thumb-nail images for ten home pages are displayed. Then, when the user selects a desired home page (for example, B) in step S122 by clicking the mouse, the user is automatically connected to the selected home page in step S123, as shown in FIG. 10. In step S124, it is determined whether end or not of the “Home Page” processing application. If not, the process returns back to step S121, and the thumb-nail is displayed again to wait for the next input.

### Goods Processing

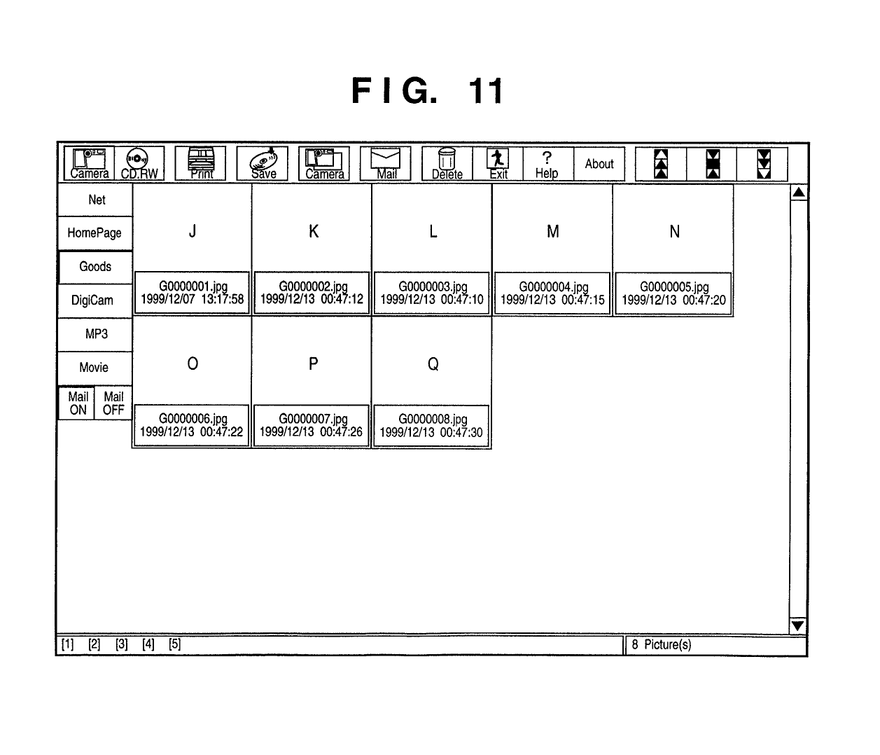

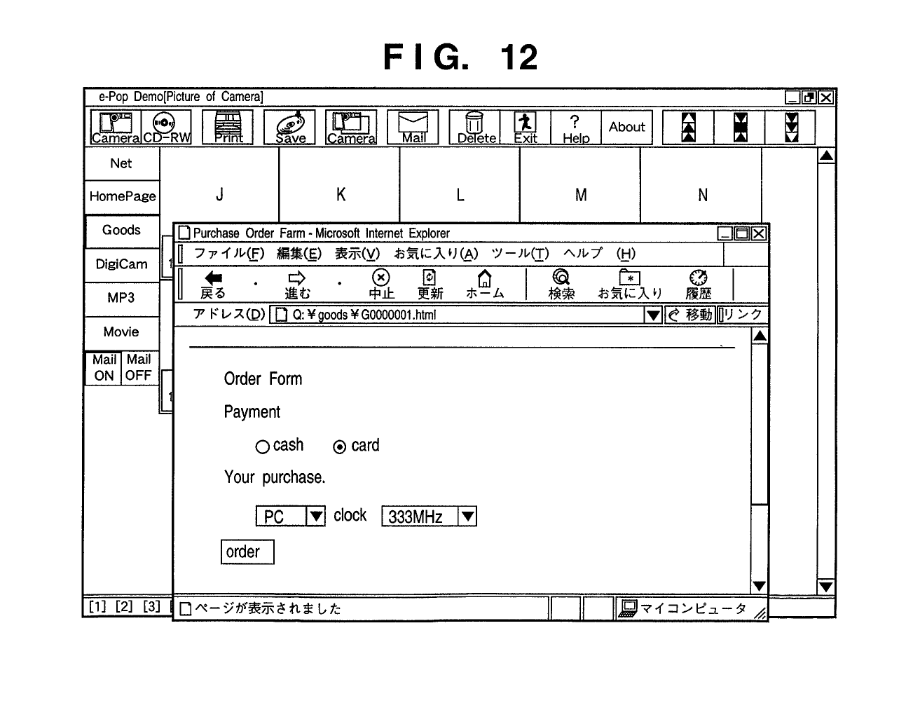

When “Goods” is selected, the process proceeds from step S130 to S131, and as shown in FIG. 11, thumb-nail images showing the kind of products to be sold are displayed. FIG. 11 shows J to Q. The thumb-nail images displayed in this step however include marks and trademarks of the maker or the securities companies, and other items regarding sales, such as tickets for theatrical performances and movies, and reservation of airplanes and trains. Then, in step S132, upon user's selection of a desired goods to be purchased by clicking the mouse, a method of sale is set and an order is established in step S133 as shown in FIG. 12. In this case, it is needless to mention that the user equipment and the user are identified. The prepaid information stored in the prepaid information area may be used. In step S134, it is determined whether end or not of the “Goods” processing application. If not, the process goes back to step S131, and the thumb-nail images are displayed again to wait for the next input.

### DigiCam Processing

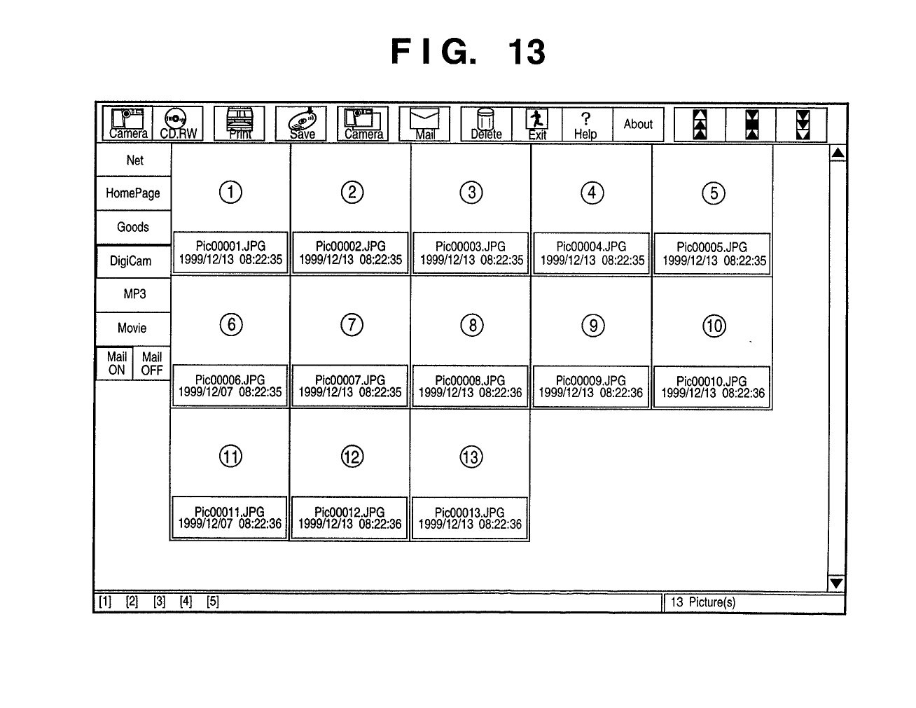

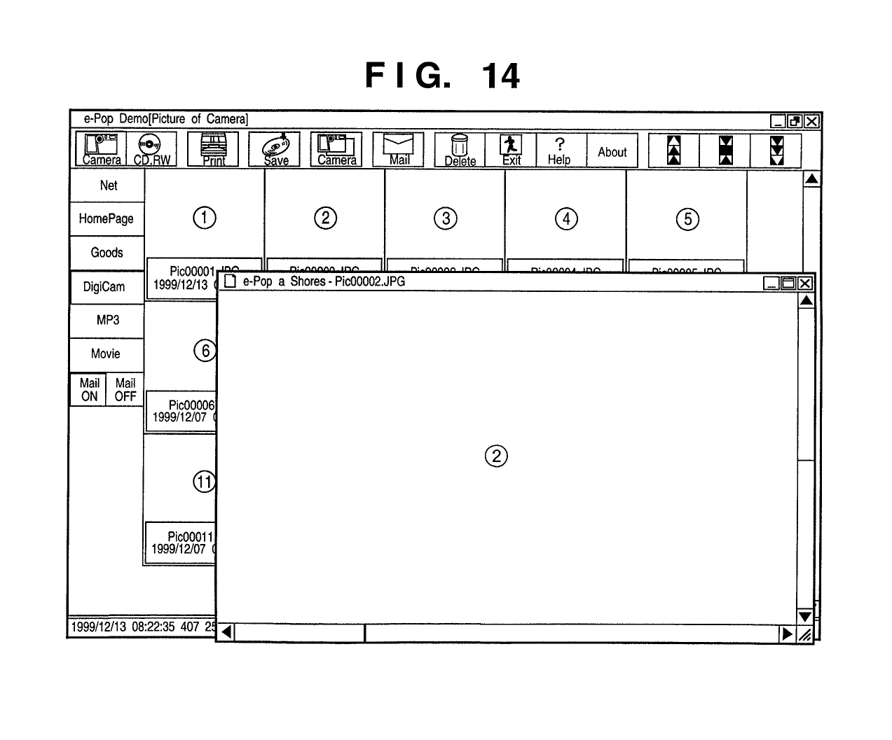

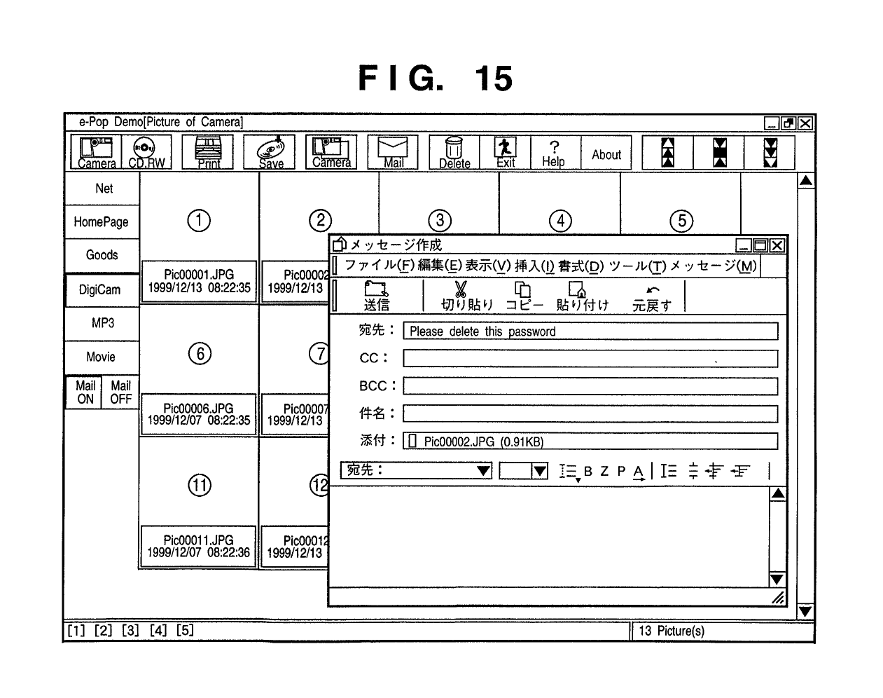

When “DigiCam” is selected, the process goes from step S140 to S141, and as shown in FIG. 13, thumb-nail images showing a digital camera pictures. While 13 thumb-nail images are displayed in FIG. 13, images exceeding 15 are displayed in page 2 and subsequent pages, and scrolling to the preceding or following page. Then, in step S142, user selects a desired picture by clicking the mouse. In step S143, the image clicked is displayed in an enlarged size, or the picture is printed on a printer as shown in FIG. 14, or processing such as editing is executed as shown in FIG. 15.

The lower-level processing of the “DigiCam” processing will briefly shown below:

Image

Display of an image data list

Selection of image data on CD-RW

Read of image data on CD-RW

Startup of retouch software

Image data retention is stored in JPEG and BMP formats in CD-RW

Image printing

Selection and printing of image

Special printing (printing of multiple sheets)

Digital camera

Read and display of image

Selection and retention of image

File editing

Retrieval, display, reproduction

Copying, transfer, deletion, synthesis, retention

Automatic retention of file

Manual retention of file

Change of file name

Specification of place of retention

Input of comments

In step S144, it is determined whether end or not of the “DigiCam” processing application. If not, the process goes back to step S141, and the thumb-nail image is displayed again to wait for the next input.

### MP3 Processing

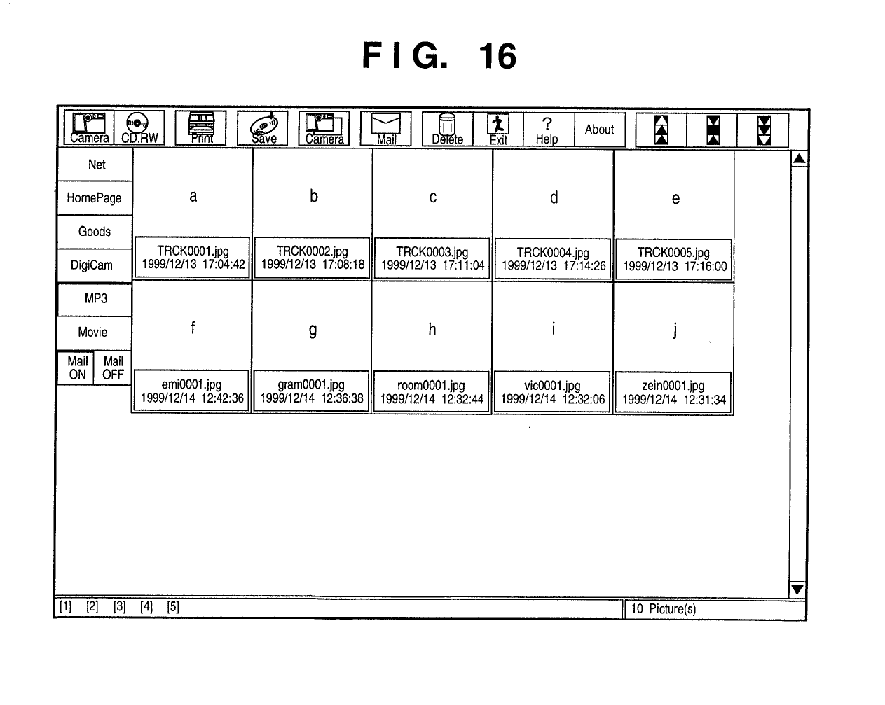

When “MP3” is selected, the process proceeds from step S150 to S151, and thumb-nail images representing companies or artists supplying voice and music are displayed in spaces a to j in FIG. 16. Then, in step S152, the user selects a desired company or artist by clicking the mouse. Upon this input, a commercial of new musics or a part of reading aloud is output in step S153. The user selects whether purchase or not in step S154. If not, the process returns back to step S151, and the thumb-nail image is displayed again to wait for the next input. When purchasing, the process goes to step S155, and a method of payment of the proceeds is set. After attestation of setting, the contents are downloaded via internet in step S156. The thumb-nail image is registered so as to be capable of subsequent selection. In step S157, it is determined whether end or not of the “MP3” processing application. If not, the process goes back to step S151, and the thumb-nail image is displayed again to wait for the next input.

### Movie Processing

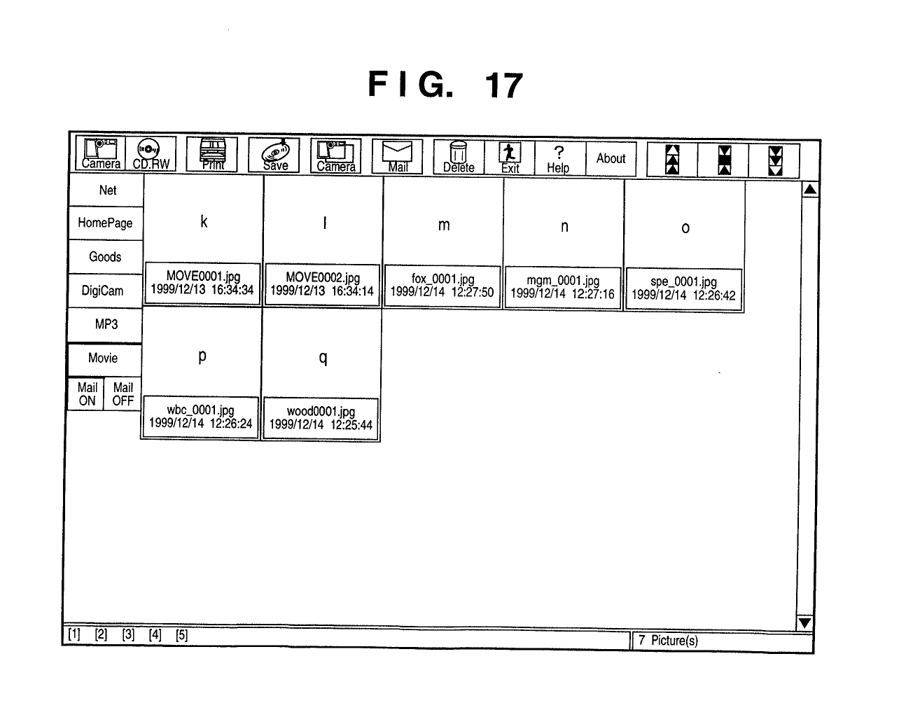

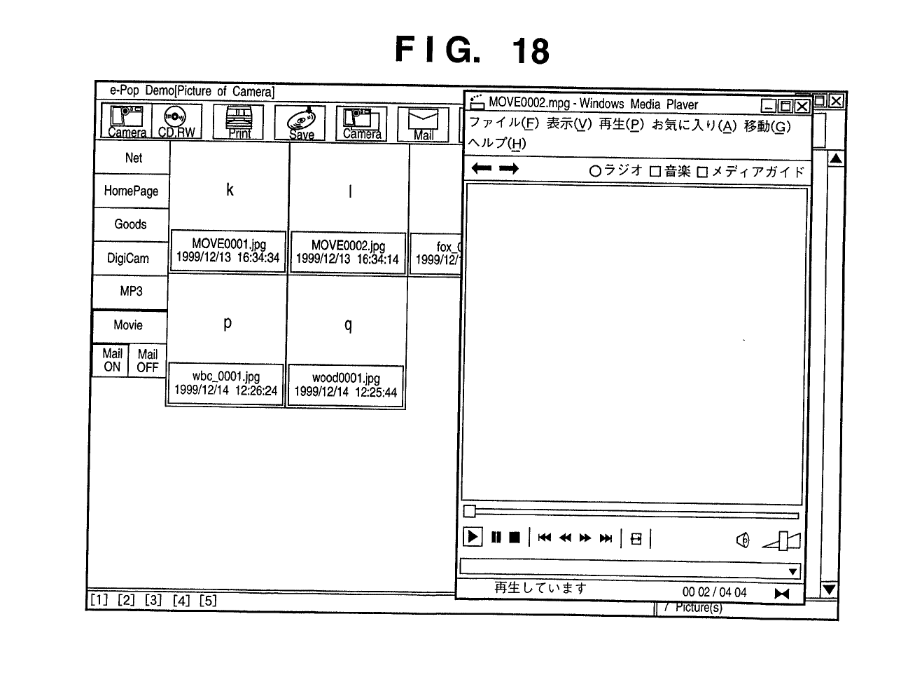

When “Movie” is selected, the process proceeds from step S160 to S161, and thumb-nail images representing the companies supplying movies and video or pieces of work are displayed in spaced k to q in FIG. 17. Then, in step S162, the user selects a desired company or piece of work by clicking the mouse in step S162, and in step S163, as shown in FIG. 18, a part of the image or the like is output as commercial information. In step S164, the user selects purchase or not. If not, the process returns back to step S161, and the thumb-nail images are displayed again to wait for the next input. If purchasing, the process proceeds to step S165, and a method of payment is set. Upon attestation of setting, the contents are downloaded via internet in step S166, and the thumb-nail image is registered to as to be capable of being selected subsequently. In step S167, it is determined whether end or not of the “Movie” processing application. If not, the process returns back to step S161, and the thumb-nail images are displayed again to wait for the next input.

While the above-mentioned embodiment has been described with a CD-RW as the storage medium. The storage medium may however be one of an optical disk such as a CD-R and a DVD, a magneto-optical disk, a semiconductor memory, and a card such as an IC card, a smart card, and a compact flash card.

The case with a general-purpose computer used as an information processing unit has been described above. However, the present invention is characterized by storage by the storage medium, and mountable, not only to a special machine such as a cellular phone or an electronic notebook, a wired telephone set and a facsimile machine, but also to all home electrical appliances only if it is an information processing unit capable of mounting this storage medium.

According to the present invention, it is possible to provide a storage medium which permits automatic startup of a system by insertion or installation of the storage medium, and totally achieves commercial display of various services, internet services such as contract procedure, purchase of goods and guide and retrieval, and user information management, an information management method and an information processing system using such a storage medium.

The invention has described by means of the preferred embodiments. The invention is not however limited to the aforementioned embodiments, but various variants are possible within ranges set forth in claims.

What is claimed is:

1. An information management method in an information processing system including a network capable for dealing with information such as images, music, voice and documents in large volumes at high speeds, comprising the steps of:
when connecting a removable storage medium having a program storage area storing programs and an information storage area storing information, to an information processing unit such as a computer on the network, selectively displaying header thumb-nail images corresponding to commercial information such as images, music, voice and documents stored by said storage medium in the information storage area thereof by operating programs stored by said storage medium in the program storage area thereof by said information processing unit; and
calling and displaying of corresponding commercial information, and/or purchase of information corresponding to said commercial information, and/or purchase of information corresponding to said commercial information, and/or connection to, or registration of, a service provider on the network corresponding to said commercial information, in accordance with selection and instruction of thumb-nail images desired by the operator.

2. An information management method according to claim 1, wherein said method comprises, when purchasing information corresponding to said commercial information, downloading the purchased information into the information storage area of said storage medium, or permitting a commodity purchase procedure of the purchased information, and when downloading the purchased information in the information storage area of said storage medium, registering the header thumb-nail image corresponding to said downloaded information in the information storage area of said storage medium.

3. An information management method according to claim 1, wherein said method comprises, when connecting to the service provider or registration thereof corresponding to said commercial information, downloading the commercial information of said service provider into the information storage area of said storage medium, and registering a header thumb-nail image corresponding to said commercial information in the information storage area of said storage medium.

4. An information management method according to claim 1, comprising the steps of further storing information prepared by the operator such as images, music, voice and documents in the information storage area of said storage medium, selectively displaying header thumb-nail images, and reading out and displaying said information in the same manner as in said commercial information.

5. An information management method according to claim 1, wherein said commercial information includes at least one of a still picture, an animation and voice.

6. An information management method according to claim 5, wherein said animation includes video information, and said voice includes music information.

7. An information management method according to claim 1, wherein said commercial information includes at least one of network registration and contract information, various contracts information, current affairs information, bicycle race and horse race information, cooking information, fortune-telling information, calendar information, home page information, guide information, sales information and rental information.

8. An information management method according to claim 7, wherein said guide information includes sight-seeing guide, shopping, guide, book guide, education guide, employment guide, housing guide, event guide, marriage guide and fashion guide.

9. An information processing system including a network, capable of processing information of images, voice and documents in large volumes at high speeds, comprising:
a removable storage medium having a program storage area storing programs and an information storage area storing information; and an information processing unit, such as a computer on the network, dismountably mounting said storage medium;
wherein said information processing unit comprises, when said storage medium is inserted,
display means selectively displaying a header thumb-nail image corresponding to commercial information such as images, music, voice and documents stored by said storage medium in the information storage area thereof by operating a program stored by said storage medium in the program storage area thereof; and
service starting means for calling and displaying of the corresponding commercial information, and/or purchase of information corresponding to said commercial information, and/or connection to, or registration of, a service provider on the network corresponding to said commercial information, in accordance with selection and instruction of a desired thumb-nail image by the operator.

10. An information processing system according to claim 9, wherein, when purchasing information corresponding to said commercial information, said system further comprises:
means for taking commodity purchasing procedure of information to be purchased;
means for downloading the purchased information into the information storage area of said storage medium when the purchased information can be downloaded; and
means for registering the header thumb-nail image corresponding to said downloaded information in the information storage area of said storage medium when downloading the purchased information in the information storage area of said storage medium.

11. An information processing system according to claim 9, wherein, when connecting to, or registering, a service provider corresponding to said commercial information, said system further comprises:
means for downloading commercial information of said service provider onto the information storage area of said storage medium; and
means for registering the header thumb-nail image corresponding to said commercial information in the information storage area of said storage medium.

12. An information processing system according to claim 9, wherein said storage medium further stores information prepared by the operator such as images, music, voice and documents in the information storage area thereof;
said display means selectively displays the header thumb-nail image corresponding to said information; and
said service starting means reads out and displays said information like obtaining said commercial information in accordance with selection and instruction of the desired thumb-nail image by the operator.

13. A removable storage medium having a storage section comprising a program storage area storing programs and an information storage area storing information, and an electronic circuit section mounting electronic circuits processing information, storing:
commercial information such as images, music, voice and documents, and thumb-nail information corresponding to said commercial information in said information storage area; and a program storage area, storing:
a first program module which selectively displays a header thumb-nail image corresponding to the commercial information such as images, music, voice and documents stored by said storage medium in the information storage area thereof, through operation of a program stored by said storage medium in the program storage area thereof by said information processing unit such as a computer; and
a second program module for calling and displaying of commercial information, and/or purchase of information corresponding to said commercial information, and/or connection to, or registration of, a service provider on the network corresponding to said commercial information, in accordance with selection and instruction of a thumb-nail image desired by the operator,
in said program storage area.

14. A storage medium according to claim 13, wherein said second program module comprises, when information corresponding to said commercial information is purchased, the steps of downloading the purchased information in the information storage area of said storage medium, and registering a header thumb-nail image corresponding to said downloaded information in the information storage area of said storage medium.

15. A storage medium according to claim 13, wherein, when connection to, or registration of, a service provider corresponding to said commercial information has been done, said second program module comprises the steps of downloading the commercial information of said service provider into the information storage area of said storage medium, and registering a header thumb-nail image corresponding to said commercial information in the information storage area of said storage medium.

16. A storage medium according to claim 13, wherein the information storage area of said storage medium further stores information such as images, music, voice and documents prepared by an operator; and said first program module comprises the step of selectively displaying the header thumb-nail image corresponding to said information, and said second program module comprises the step of reading out and displaying said information like said commercial information in accordance with selection and instruction of a thumb-nail image desired by the operator.

17. A storage medium according to claim 13, wherein said storage medium has a special read-only area and a writable area.

18. A storage medium according to claim 13, wherein said program storage area further stores a bootstrap program and a system program which is read out by said bootstrap program and controls said first and second program modules.

19. A storage medium according to claim 13, wherein said storage medium is an optical disk.
